(19) United States
(12) Patent Application Publication
(10) Pub. No.: US 2013/0081519 A1
(43) Pub. Date: Apr. 4, 2013

(54) Phillips line jipper

(71) Applicants: Donald Arthur Phillips, Lansing, MI (US); William Thomas Phillips, Eaton Rapids, MI (US)

(72) Inventors: Donald Arthur Phillips, Lansing, MI (US); William Thomas Phillips, Eaton Rapids, MI (US)

(21) Appl. No.: 13/200,747

(22) Filed: Sep. 30, 2011

(51) Int. Cl. B25B 13/50

(52) U.S. Cl. 81/64

(57) ABSTRACT

Disclosed is an open-end line socket tool that can be used to tighten or loosen a hexagonal line nut in a hydraulic line fitting. The tool body includes sidewalls defining a hexagonal outer cross section perpendicular to its length and an open interior volume extending the length of the tool body and through a sidewall thereof. The open interior volume includes (i) a hexagonal recess at one end of the tool body, the hexagonal recess being sized and shaped to receive a hexagonal line nut, and (ii) a channel adjacent the hexagonal recess and extending to an opposing end of the tool body, the channel being sized and shaped to accommodate a hydraulic line passing from the open interior volume to an exterior of the tool body. The tool body sidewalls include an interior sidewall shoulder defining a contraction in the open interior volume from the hexagonal recess to the channel. Two opposing flexible sidewalls of the tool body are capable of tightening when the tool is used with a wrench to tighten or loosen a hexagonal line nut, thereby improving the connection thereto.

### TECHNICAL FIELD

The open-end line socket as disclosed herein pertains to the mechanical field. This invention relates particularly to the removal and installation of hydraulic line connection nuts.

### BACKGROUND OF THE INVENTION

Line wrenches are used as the primary tool of choice in removing hydraulic line connector nuts. The fixed walls of these line wrench do not flex to create a better connection and allows the wrench to round over the hex, stripping the nut and creating damage that may necessitate the replacement of the entire line. This invention will aid in the reduction of these problems saving both time and expense.

### SUMMARY OF THE INVENTION

### Technical Problem

Fixed wall tools are unable to flex and as a result can cause the wrench to slip over the connecting nut and necessitate the removal of the hydraulic line.

### Solution to the Problem

This invention will allow a flexible sidewall 22A tool 10 to go over a hydraulic line and work as a socket. Used with a line wrench this tool 10 will create the best connection possible and eliminate the need to cut and replace the entire hydraulic line.

### Advantageous Effects of the Invention

The advantages of this invention are that by reducing the replacement of hydraulic lines saves time, expense, and reduce the amount of hazardous fluids to be disposed of. The effects are that service costs can be reduced, allowing these allocations to be better used. The effects on the environment are that fewer toxic chemicals make it out and into the ecosystem.

### BRIEF DESCRIPTION OF THE DRAWINGS

The following drawings of the tool 10 are drawn at one size and not to scale. This tool 10 is intended for use with many size dimensions both standard and metric to accommodate as many line nuts as possible.

FIG. 1 is a front view elevation of an open-end line socket tool 10 according to the disclosure. This view shows the socket area 32 and the open area 34 to accommodate the hydraulic line.

FIG. 2 (view 2-2 of FIG. 1) is a side view elevation of the open-end line socket tool 10. This is a view of the interior 30 of the invention. It clearly demonstrates the cut 34 through the sidewall 22 to allow a line to pass inside the tool 10 so that the tool 10 can be placed on the connecting nut as securely as a socket.

FIG. 3 (view 3-3 of FIG. 1) is an exploded view elevation of the open-end line socket tool 10. This is an exploded view to the invention. It shows both the cut 34 through the sidewall 22 and recess 32 to receive the connecting nut.

The drawings are not to scale as the tool will be manufactured to fit a large size range in both standard and metric sizes.

### DETAILED DESCRIPTION

Description: This is a tool 10 that resembles a common socket. Its difference being one side 22 milled and cut through to accommodate a hydraulic line as to allow a socket type of connection 34 to the fastening nut.

Manufacture: The tool 10 is turned on a screw machine using hex bar 20 stock. It is broached In the inner diameter to a hex and size dimension, milled and cut through on one side 22 on secondary machines.

Use: Used with a common line wrench, the tool 10 creates a tighter connection and reduces the chance of rounding the tightening surfaces over, necessitating the removal and replacement of the connector.

This tool 10 will remove and aid in the installation of hydraulic line fittings better than any other tool.

The unique design of this tool 10 allows the sidewalls 22A to tighten around the nut flats giving the tool 10 a better connection than a fixed walled tool.

The ability to decrease space between the tool 10 and the nut surfaces reduces stripping or rounding over the hex of the nut.

This tool 10 decreases the need to replace hydraulic lines due to line nut damage.

This tool 10 also aids with the installation of line nuts by giving the Installer more surface 22, 22A connection with which to turn the nut.

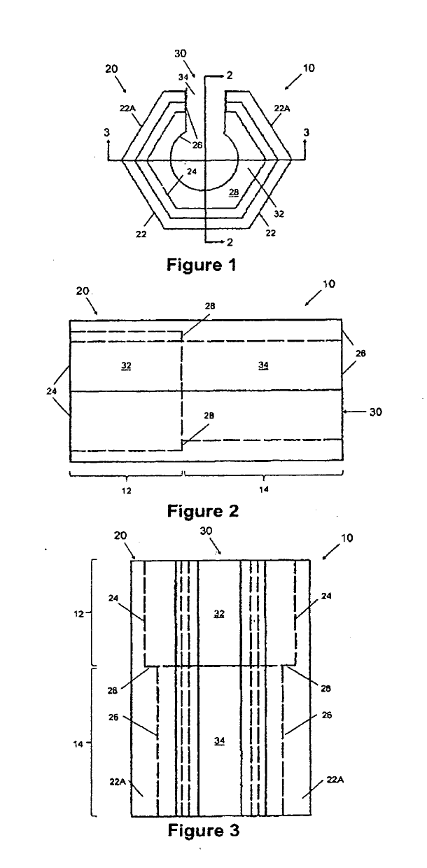

Table 1 below provides a listing with reference numerals for the various structural elements illustrated in FIGS. 1-3.

TABLE 1
Open-End Line Socket Structural Elements

| Reference | Structural Element |
|---|---|
| 10 | Open-end line socket tool |
| 12 | Proximal end/region of tool 10 |
| 14 | Distal end/region of tool 10 |
| 20 | Hexagonal body/outer surface of tool 10 |
| 22 | Outer sidewall of body 20/tool 10 |
| 22A | Flexible outer sidewall of body 20/tool 10 |
| 24 | Interior sidewall of body 20/tool 10 |
| | defining hexagonal recess 32 |
| 26 | Interior sidewall of body 20/tool 10 |
| | defining longitudinal channel 34 |
| 28 | Interior sidewall shoulder of body 20/tool |
| | 10 defining contraction between recess |
| | 32 and channel 34 |
| 30 | Open interior volume defined by interior |
| | sidewalls 24, 26, 28 of body 20/tool 10 |
| 32 | Hexagonal recess/socket area defined by |
| | interior sidewalls 24 of body 20/tool 10 |
| 34 | Channel/open area defined by interior |
| | sidewalls 26 of body 20/tool 10 |

### INDUSTRIAL APPLICABILITY

This tool is applicable to all industries using hydraulic lines with a mechanical connection.

1.-5. (canceled)

6. An open-end line socket tool comprising:
(a) a tool body having a length and comprising sidewalls defining a hexagonal outer cross section perpendicular to the length of the tool body; and
(b) an open interior volume (1) defined by the tool body sidewalls and (2) extending the length of the tool body and through a sidewall thereof, the open interior volume comprising:
(i) a hexagonal recess at a proximal end of the tool body, the hexagonal recess being sized and shaped to receive a hexagonal line nut, and
(ii) a channel adjacent the hexagonal recess and extending to a distal end of the tool body, the channel being sized and shaped to accommodate a hydraulic line passing from the open interior volume to an exterior of the tool body;
wherein the tool body sidewalls comprise an interior sidewall shoulder defining a contraction in the open interior volume from the hexagonal recess to the channel.

7. The tool of claim 6, wherein:
(i) the tool body comprises two opposing flexible sidewalls at least partially defining the open interior volume; and
(ii) the flexible sidewalls are capable of tightening when the tool is used with a wrench to tighten or loosen a hexagonal line nut.

8. A method for tightening or loosening a hexagonal line nut, the method comprising:
(a) providing the open-end line socket tool of claim 6;
(b) providing a hydraulic line fitting comprising a hexagonal line nut and a hydraulic line extending therefrom;
(c) fitting the hexagonal recess of the tool over the hexagonal line nut such that the hydraulic line passes from the open interior volume to an exterior of the tool body; and
(d) tightening or loosening the hexagonal line nut with a wrench engaging outer sidewalls of the tool body.

9. A method for tightening or loosening a hexagonal line nut, the method comprising:
(a) providing the open-end line socket tool of claim 7;
(b) providing a hydraulic line fitting comprising a hexagonal line nut and a hydraulic line extending therefrom;
(c) fitting the hexagonal recess of the tool over the hexagonal line nut such that the hydraulic line passes from the open interior volume to an exterior of the tool body; and
(d) tightening or loosening the hexagonal line nut with a wrench engaging outer sidewalls of the tool body such that the flexible sidewalls tighten, thereby decreasing the space between the tool and the hexagonal line nut to improve the connection therebetween.
